(19) United States
(12) Patent Application Publication
(10) Pub. No.: US 2010/0314899 A1
(43) Pub. Date: Dec. 16, 2010

(54) MULTIPLE HITCH HOLDER

(76) Inventor: STEVE SLACKS, Waterford, CA (US)

Correspondence Address: LAW OFFICE OF JERRY D. HAYNES , P.A, P.O. Box 350392, Fort Lauderdale, FL, 33335, US

(21) Appl. No.: 12/483,202

(22) Filed: Jun. 11, 2009

(51) Int. Cl. B60R 11/06

(52) U.S. Cl. 296/37.6

(57) ABSTRACT

The present invention relates to a multiple hitch holding system for use in a cargo bed comprising: a plurality of holding bins; and a mounting mechanism, where said holding bins are affixed to the mounting mechanism and said mounting mechanism attaches the plurality of holding bins to a cargo bed side wall. In one exemplary embodiment, the mounting mechanism includes a rectangular tube and the plurality of holding bins is aligned in parallel along one side of the rectangular tube. The rectangular tube may include at least one opening at a first end and a second end, where said openings provide a mechanism for insertion of fasteners. The fasteners provide a mechanism secure the hitch holding system to an inside wall of the cargo bed.

### BACKGROUND OF THE INVENTION

1. Field of Invention

The present invention relates to a storage compartment accessory that may be attached to open cargo bed of a pickup truck.

2. Description of Related Art

Various types of storage compartments have been developed for open cargo bed areas of pickup trucks, flat bed truck, cargo trucks and the like. The cargo compartments developed in the prior art are primarily a toolbox design where the box or compartment attaches or is secured to some portion of the cargo area. The compartment may vary in size and configuration. Some cargo compartments are designed to be removable and others permanently affixed to the truck. A group of storage compartments have been designed where they remain open and others include a lid or covering to enclose and perhaps secure the contents thereof. Yet other storage compartments are actually a collapsible, such as U.S. Pat. No. 5,853,116 where the compartments are collapsed when not in use. Consequently all of the storage compartments for cargo bed storage have been designed for their specific needs and consequently take up space in or near the cargo bed area.

Many pickup trucks are utilized for towing purposes and consequently need multiple hitches as an attachment means for towing. Hitches come in various sizes and shapes to accommodate different trailers. Some hitches are interchangeable to provide the user with flexibility and breath in use. When a truck owner has the capability and changed hitches, the owner therefore needs a means to store the hitches when not in use. One option is to place the extra hitches in a storage compartment area that may be designed to hold tools or other equipment within the cargo bed area. Many times these compartments may become disorganized and it may necessitate searching for the hitch within the storage compartment. The hitches may be lost with other materials that may be placed in the cargo bed or storage compartment and therefore inconvenience for the user to locate when necessary. Therefore a need exists for a cargo compartment or hitch storage unit that is specifically designed to store multiple hitches for use on a pickup service or flatbed truck.

### SUMMARY OF THE INVENTION

The present invention relates to a multiple hitch holding system for use in a cargo bed comprising: a plurality of holding bins; and a mounting means, where said holding bins are affixed to the mounting means and said mounting means attaches the plurality of holding bins to a cargo bed side wall. In one exemplary embodiment, the mounting means includes a rectangular tube and the plurality of holding bins is aligned in parallel along one side of the rectangular tube. The rectangular tube may include at least one opening at a first end and a second end, where said openings provide a means for insertion of fasteners. The fasteners provide a means secure the hitch holding system to an inside wall of the cargo bed.

### BRIEF DESCRIPTION OF DRAWINGS

FIG. 1 depicts a hitch storage compartment according to the present invention.

### DETAILED DESCRIPTION

The present invention provides a hitch storage compartment that may be easily attached to the cargo bed area of a pickup or service truck. The hitch storage compartment according to the present invention provides a means to store multiple hitches in small compartments that may abut a wall of the cargo area and therefore take up minimum storage space but yet provide an easy means to locate the hitches utilized on the truck.

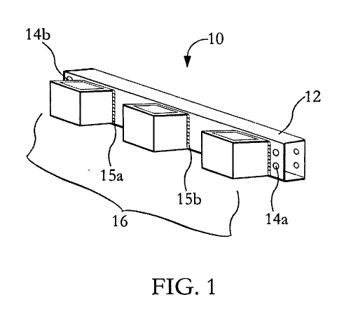

A multiple hitch holder 10 according to the present invention is depicted in FIG. 1. The hitch holder 10 includes a plurality of holding bins 16 along one side of a rectangular metal brace. As contemplated by the present invention the multiple holding bins 16 are welded onto a steel rectangular tube 12. The width of the rectangular tube 12 may be sufficient to accommodate the desired number of hitch holding bins 16 as the desire for the user. Spot-welds 15a, 15b are shown which provide a means to secure the hitch holding bins 16 onto the rectangular tubing 12. Consequently, the hitch holding bins 16 are permanently affixed onto the rectangular tubing 12 and are welded on each side thereof in order to secure the holding bins 16 to the rectangular tubing 12.

The rectangular tubing 12 includes openings for the insertion of fasteners. Openings 14a and 14b depicted at opposite ends of the rectangular tubing 12 provide a means to secure the multiple hitch holding system 10 to the inside wall of a cargo bed. The hitch holders 16 include an opening at the top thereof to allow for the insertion of hitches into the hitch holding bins 16. Once the hitch holding assembly 10 is placed into position in a cargo bed a hitch may be easily stored in each individual hitch holding bin 16.

The hitch holding system 10 according to the present invention may be made of mild steel with a powder or plated coating to prevent rust. The hitch holding system 10 according to present invention may store and secure various types of hitches such as tow ball or clevis hitches. The hitch holding system 10 may also include a locking mechanism to actually secure the hitches to prevent theft thereof. The hitch holding system 10 provides a beneficial accessory for an individual and also conducive for industrial applications such as agriculture, chemical or construction industries. The installation of the hitch holding assembly 10 simply requires fasteners for insertion into openings 14a, 14b and the necessity of a drill to provide holes for receipt of the fasteners into the sidewall of the cargo bed. In one exemplary embodiment, the rectangular tubing 12 may be up to 16 inches long with three hitch holding bins that are about 5 square inches an area.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

What is claimed is:

1. A multiple hitch holding system for use in a cargo bed comprising:
a. a plurality of holding bins; and
b. a mounting means, where said holding bins are affixed to the mounting means and said mounting means attaches the plurality of holding bins to a cargo bed side wall.

2. The multiple hitch holding system according to claim 1, where the mounting means includes a rectangular tube and the plurality of holding bins are aligned in parallel along one side of the rectangular tube.

3. The multiple hitch holding system according to claim 2, where said rectangular tube includes at least one opening at a first end and a second end, where said openings provides a means for insertion of fasteners, said fasteners providing a means secure the hitch holding system to an inside wall of the cargo bed.

4. The multiple hitch holding system according to claim 1, where the plurality of bins and mounting means are made of a mild steel with a protective coating.

5. The multiple hitch holding system according to claim 1, further comprising a locking mechanism.

6. A multiple hitch holding system for use in a cargo bed comprising:
a. at least three holding bins; and
b. a mounting means, where said holding bins are affixed to the mounting means and said mounting means attaches the at least three holding bins to a cargo bed side wall.

7. The multiple hitch holding system according to claim 1, where the mounting means includes a rectangular tube and the at least three holding bins are aligned in parallel along one side of the rectangular tube.

8. The multiple hitch holding system according to claim 2, where said rectangular tube includes at least one opening at a first end and a second end, where said openings provides a means for insertion of fasteners, said fasteners providing a means secure the hitch holding system to an inside wall of the cargo bed.

9. The multiple hitch holding system according to claim 1, where the at least three bins and mounting means are made of a mild steel with a protective coating.

10. The multiple hitch holding system according to claim 1, further comprising a locking mechanism.
